(19) United States
(12) Patent Application Publication
(10) Pub. No.: US 2025/0044871 A1
(43) Pub. Date: Feb. 6, 2025

(54) TIMELINE BASED REPRESENTATION FOR HAPTIC SIGNAL

(71) Applicant: InterDigital CE Patent Holdings, SAS, Paris (FR)

(72) Inventors: Quentin Galvane, Thorigne-Fouillard (FR); Fabien Danieau, Rennes (FR); Philippe Guillotel, Vern sur Seiche (FR)

(21) Appl. No.: 18/715,830

(22) PCT Filed: Nov. 8, 2022
(86) PCT No.: PCT/EP2022/081123

§ 371 Date: Jun. 3, 2024

(30) Foreign Application Priority Data
Dec. 2, 2021 (EP) 21306693.9
Mar. 15, 2022 (EP) 22305295.2

(51) Int. Cl. G06F 3/01

(52) U.S. Cl. CPC G06F 3/016; G06F 3/011

(57) ABSTRACT

A data structure storing information representative of haptic effects comprises a set of haptic effects and a timeline. Haptic effects may be defined in a flexible manner, either directly within the timeline or referenced by an identifier within the timeline. A library may store definitions of the effects with associated identifiers. Data restructuring processes are proposed to convert from a streaming-friendly format where the library is not used to an edition friendly format with the use of a library, and vice versa.

### TECHNICAL FIELD

At least one of the present embodiments generally relates to haptics and more particularly to the definition of a representation format for haptic objects in immersive scenes based on a timeline.

### BACKGROUND

Fully immersive user experiences are proposed to users through immersive systems based on feedback and interactions. The interaction may use conventional ways of control that fulfill the need of the users. Current visual and auditory feedback provide satisfying levels of realistic immersion. Additional feedback can be provided by haptic effects that allow a human user to perceive a virtual environment with his senses and thus get a better experience of the full immersion with improved realism. However, haptics is still one area of potential progress to improve the overall user experience in an immersive system.

Conventionally, an immersive system may comprise a 3D scene representing a virtual environment with virtual objects localized within the 3D scene. To improve the user interaction with the elements of the virtual environment, haptic feedback may be used through stimulation of haptic actuators. Such interaction is based on the notion of “haptic objects” that correspond to physical phenomena to be transmitted to the user. In the context of an immersive scene, a haptic object allows to provide a haptic effect by defining the stimulation of appropriate haptic actuators to mimic the physical phenomenon on the haptic rendering device. Different types of haptic actuators allow to restitute different types of haptic feedbacks.

An example of a haptic object is an explosion. An explosion can be rendered though vibrations and heat, thus combining different haptic effects on the user to improve the realism. An immersive scene typically comprises multiple haptic objects, for example using a first haptic object related to a global effect and a second haptic object related to a local effect.

The principles described herein apply to any immersive environment using haptics such as augmented reality, virtual reality, mixed reality or haptics-enhanced video (or omnidirectional/360° video) rendering, for example, and more generally apply to any haptics-based user experience. A scene for such examples of immersive environments is thus considered an immersive scene.

Haptics refers to sense of touch and includes two dimensions, tactile and kinesthetic. The first one relates to tactile sensations such as friction, roughness, hardness, temperature and is felt through the mechanoreceptors of the skin (Merkel cell, Ruffini ending, Meissner corpuscle, Pacinian corpuscle). The second one is linked to the sensation of force/torque, position, motion/velocity provided by the muscles, tendons and the mechanoreceptors in the joints. Haptics is also involved in the perception of self-motion since it contributes to the proprioceptive system (i.e. perception of one's own body). Thus, the perception of acceleration, speed or any body model could be assimilated as a haptic effect. The frequency range is about 0-1 KHz depending on the type of modality. Most existing devices able to render haptic signals generate vibrations. Examples of such haptic actuators are linear resonant actuator (LRA), eccentric rotating mass (ERM), and voice-coil linear motor. These actuators may be integrated into haptic rendering devices such as haptic suits but also smartphones or game controllers.

To encode haptic signals, several formats have been defined related to either a high level description using XML-like formats (for example MPEG-V), parametric representation using json-like formats such as Apple Haptic Audio Pattern (AHAP) or Immersion Corporation's HAPT format, or waveform encoding (IEEE 1918.1.1 ongoing standardization for tactile and kinesthetic signals). The HAPT format has been recently included into the MPEG ISOBMFF file format specification (ISO/IEC 14496 part 12). Moreover, GL Transmission Format (glTF™) is a royalty-free specification for the efficient transmission and loading of 3D scenes and models by applications. This format defines an extensible, common publishing format for 3D content tools and services that streamlines authoring workflows and enables interoperable use of content across the industry.

Moreover, a new haptic file format is being defined within the MPEG standardization group and relates to a coded representation for haptics. The Reference Model of this format is not yet released but is referenced herein as RM0. With this reference model, the encoded haptic description file can be exported either as a JSON interchange format (for example a .gmpg file) that is human readable or as a compressed binary distribution format (for example a .mpg) that is particularly adapted for transmission towards haptic rendering devices.

### SUMMARY

Embodiments are related to a data structure storing information representative of an immersive experience comprising a set of haptic effects and a timeline. Haptic effects may be defined in a flexible manner, either directly within the timeline or referenced by an identifier within the timeline. A library may store definitions of the effects with associated identifiers. Data restructuring processes are proposed to convert from a streaming-friendly format where the library is not used to an edition friendly format with the use of a library, and vice versa.

A first aspect of at least one embodiment is directed to method comprising-generating haptic data comprising information representative of a type of effect, a list of haptic effects, a list of haptic tracks, wherein a haptic track comprises a timeline wherein at least one temporal reference is associated to a haptic effect or to an identifier in the list of a haptic effects, wherein a haptic effect comprises information representative of values of a signal to be applied to render the haptic effect.

A second aspect of at least one embodiment is directed to a method for rendering haptic data comprising obtaining haptic data comprising information representative of a type of effect, a list of haptic effects, a list of haptic tracks, wherein a haptic track comprises a timeline wherein at least one temporal reference is associated to a haptic effect or to an identifier in the list of a haptic effects, wherein a haptic effect comprises information representative of values of a signal to be applied to render the haptic effect and providing values of the signal to haptic actuators.

A third aspect of at least one embodiment is directed to a haptic rendering device comprising a processor configured to obtain haptic data comprising information representative of a type of effect, a list of haptic effects, a list of haptic tracks, wherein a haptic track comprises a timeline wherein at least one temporal reference is associated to a haptic effect or to an identifier in the list of a haptic effects, wherein a haptic effect comprises information representative of values of a signal to be applied to render the haptic effect and provide values of the signal to haptic actuators.

A fourth aspect of at least one embodiment is directed to haptic data comprising information representative of a type of effect, a list of haptic effects, a list of haptic tracks, wherein a haptic track comprises a timeline wherein at least one temporal reference is associated to a haptic effect or to an identifier in the list of a haptic effects, wherein a haptic effect comprises information representative of values of a signal to be applied to render the haptic effect.

A fifth aspect of at least one embodiment is directed to a method for restructuring haptic data generated according to the first aspect wherein at least one temporal reference is associated to an identifier in the list of a haptic effects, the method comprising obtaining haptic data, analyzing the haptic data to determine identifiers of a haptic effects in timelines, replacing determined identifiers by copies of the haptic effects associated to the identifiers, emptying the list of haptic effects and providing the restructured haptic data.

A sixth aspect of at least one embodiment is directed to a method for restructuring haptic data generated according to claim 1 wherein at least one temporal reference is associated to a haptic effect, the method comprising obtaining haptic data, analyzing the haptic data to determine identical haptic effects, inserting a copy of one of the determined identical haptic effect into the list of haptic effects, associating an identifier to the inserted identical haptic effect, replacing identical haptic effects by the associated identifier, and providing the restructured haptic data.

According to a seventh aspect of at least one embodiment, a computer program comprising program code instructions executable by a processor is presented, the computer program implementing at least the steps of a method according to the first or second aspect.

According to a eighth aspect of at least one embodiment, a computer program product which is stored on a non-transitory computer readable medium and comprises program code instructions executable by a processor is presented, the computer program product implementing at least the steps of a method according to the first or second aspect.

### BRIEF DESCRIPTION OF THE DRAWINGS

FIG. 1 illustrates a block diagram of an example of a system in which various aspects and embodiments are implemented.

FIGS. 2A and 2B illustrate an example of encoding of a haptic signal based to a conventional technique using a decomposition into frequency bands.

FIG. 3 illustrates an example of data structure for haptic files according to at least a first embodiment wherein basis effects are defined based on the frequency decomposition in haptic bands.

FIG. 4 illustrates an example of data structure for haptic files according to at least a second embodiment wherein basis effects are defined based on keyframes.

FIG. 5 illustrates an example of haptic file encoded according to the second embodiment without using the effect library.

FIG. 6 illustrates an example of haptic file encoded according to the second embodiment using the effect library.

FIG. 7 illustrates an example of architecture for an encoder for haptic files according to at least one embodiment.

FIG. 8 illustrates a data restructuration process according to one embodiment.

FIG. 9 illustrates an example of process for rendering haptic data according to at least one embodiment.

### DETAILED DESCRIPTION

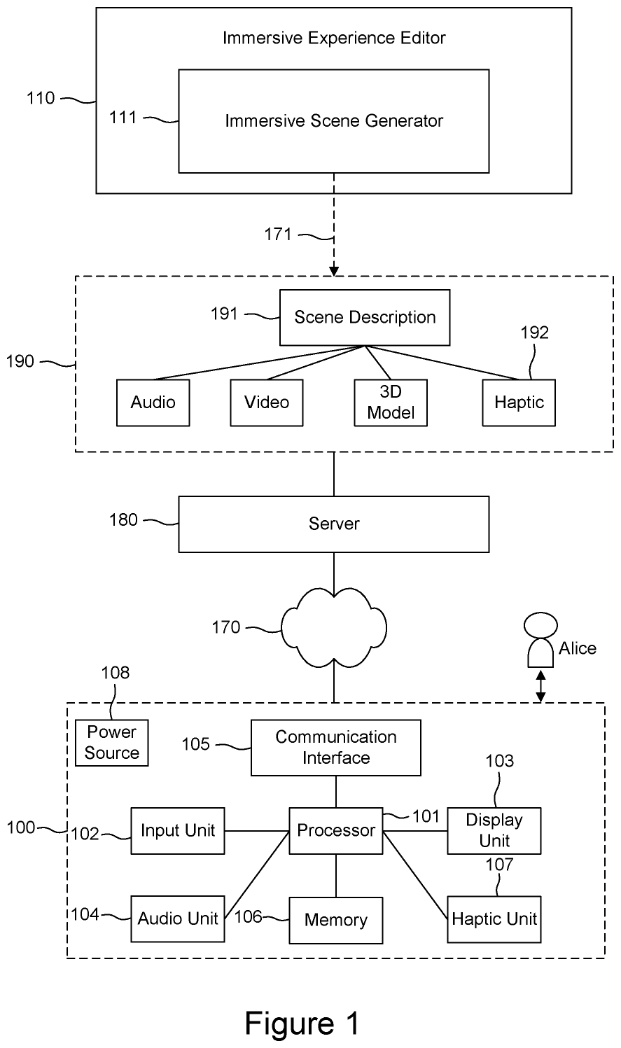

FIG. 1 illustrates a block diagram of an example of system in which various aspects and embodiments are implemented. In the depicted immersive system, the user Alice uses the haptic rendering device 100 to interact with a server 180 hosting an immersive scene 190 through a communication network 170. This immersive scene 190 may comprise various data and/or files representing different elements (scene description 191, audio data, video data, 3D models, and haptic data 192) required for its rendering. The immersive scene 190 may be generated under control of an immersive experience editor 110 that allows to arrange the different elements together and design an immersive experience. Appropriate description files and various data files representing the immersive experience are generated by an immersive scene generator 111 in a format adapted for transmission to haptic rendering devices. The immersive experience editor 110 is typically performed on a computer that will generate immersive scene to be hosted on the server. For the sake of simplicity, the immersive experience editor 110 is illustrated as being directly connected through the dotted line 171 to the immersive scene 190. In practice, the computer running the immersive experience editor 110 is connected to the server 180 through the communication network 170.

The haptic rendering device 100 comprises a processor 101. The processor 101 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as haptic signal decoding, input/output processing, and/or any other functionality that enables the device to operate in an immersive system.

The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still pictures or video. The processor 101 may be coupled to a display unit 103 configured to output visual data to be displayed on a screen. Multiple types of displays can be used for that purpose such as a liquid crystal display (LCD) or organic light-emitting diode (OLED) display unit. The processor 101 may also be coupled to an audio unit 104 configured to render sound data to be converted into audio waves through an adapted transducer such as a loudspeaker for example. The processor 101 may be coupled to a communication interface 105 configured to exchange data with external devices. The communication preferably uses a wireless communication standard to provide mobility of the haptic rendering device, such as cellular (e.g. LTE) communications, Wi-Fi communications, and the like. The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 may be coupled to a haptic unit 107 configured to provide haptic feedback to the user, the haptic feedback being described in the haptic data 192 that is related to the scene description 191 of an immersive scene 190. The haptic data 192 describes the kind of feedback to be provided according to the syntax described further hereinafter. Such description file is typically conveyed from the server 180 to the haptic rendering device 100. The haptic unit 107 may comprise a single haptic actuator or a plurality of haptic actuators located at a plurality of positions on the haptic rendering device. Different haptic units may have a different number of actuators and/or the actuators may be positioned differently on the haptic rendering device.

The processor 101 may receive power from the power source 108 and may be configured to distribute and/or control the power to the other components in the device 100.

The power source may be any suitable device for powering the device. As examples, the power source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated together in an electronic package or chip. It will be appreciated that the haptic rendering device 100 may include any sub-combination of the elements described herein while remaining consistent with an embodiment. The processor 101 may further be coupled to other peripherals or units not depicted in FIG. 1 which may include one or more software and/or hardware modules that provide additional features, functionality and/or wired or wireless connectivity. For example, the peripherals may include sensors such as a universal serial bus (USB) port, a vibration device, a television transceiver, a hands free headset, a Bluetooth® module, a frequency modulated (FM) radio unit, a digital music player, a media player, a video game player module, an Internet browser, and the like. For example, the processor 101 may be coupled to a localization unit configured to localize the haptic rendering device within its environment. The localization unit may integrate a GPS chipset providing longitude and latitude position regarding the current location of the haptic rendering device but also other motion sensors such as an accelerometer and/or an e-compass that provide localization services.

Typical examples of haptic rendering device 100 are haptic suits, smartphones, game controllers, haptic gloves, haptic chairs, haptic props, motion platforms, etc. However, any device or composition of devices that provides similar functionalities can be used as haptic rendering device 100 while still conforming with the principles of the disclosure.

In at least one embodiment, the device does not include a display unit but includes a haptic unit. In such embodiment, the device does not render the scene visually but only renders haptic effects. However, the device may prepare data for display so that another device, such as a screen, can perform the display. Example of such devices are haptic suits or motion platforms.

In at least one embodiment, the device does not include a haptic unit but includes a display unit. In such embodiment, the device does not render the haptic effect but only renders the scene visually. However, the device may prepare data for rendering the haptic effect so that another device, such as a haptic prop, can perform the haptic rendering. Examples of such devices are smartphones, head-mounted displays, or laptops.

In at least one embodiment, the device does not include a display unit nor does it includes a haptic unit. In such embodiment, the device does not visually render the scene and does not render the haptic effects. However, the device may prepare data for display so that another device, such as a screen, can perform the display and may prepare data for rendering the haptic effect so that another device, such as a haptic prop, can perform the haptic rendering. Examples of such devices are desktop computers, optical media players, or set-top boxes.

In at least one embodiment, the immersive scene 190 and associated elements are directly hosted in memory 106 of the haptic rendering device 100 allowing local rendering and interactions.

Although the different elements of the immersive scene 190 are depicted in FIG. 1 as separate elements, the principles described herein apply also in the case where these elements are directly integrated in the scene description and not separate elements. Any mix between two alternatives is also possible, with some of the elements integrated in the scene description and other elements are separate files.

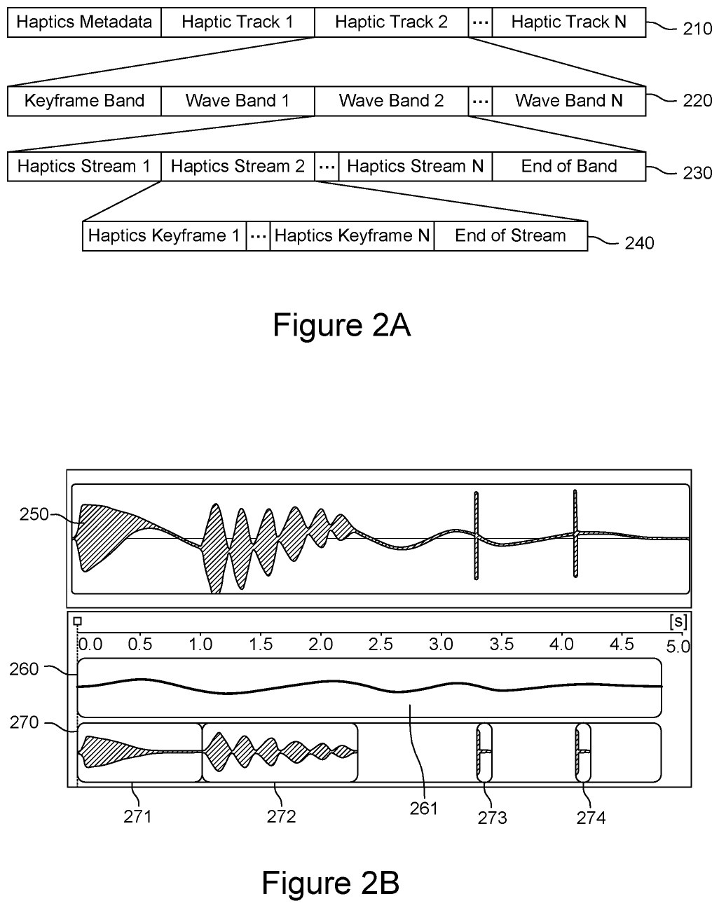

FIGS. 2A and 2B illustrate an example of encoding of a haptic signal based to a conventional technique using a decomposition into frequency bands. As shown in FIG. 2A, with this technique, a signal is encoded using a list of tracks 210 where the data is decomposed in a set of frequency bands 220. Each band defines part of the signal in a given frequency range with a list of streams. The streams 230 comprises a plurality of unitary signal keyframes 240 and handle their timing. The haptic signal in a track can be reconstructed by combining the data from the streams in the different bands. FIG. 2B shows a haptic signal 250 and a possible decomposition in two frequency bands. The band 260 is related to the first frequency band and only comprises one stream 261. The band 270 is related to the second frequency band and comprises the streams 271, 272, 273 and 274. Each stream is comprising a set of keyframes representing the values of the signal to be rendered. Temporal references such as timestamps are associated to the keyframes. By aggregating keyframes of the streams of high and low frequency bands positioned at the appropriate timestamp, the original low-level signal can be reconstructed.

One advantage of this solution with regards to the structure is that the signal data is easy to package and particularly convenient for streaming purposes Indeed, with such linear structure, the data can be easily broken down to small consecutive packages and does not require complicated data-pre-fetching operations. The signal is easily reconstructed by patching the packages back together to ensure a smooth playback of the signal.

However, with this approach, a part of the signal that is repeated multiple times must be stored multiple times. This linear representation of the data might be convenient for streaming purposes but may be counter-productive for other purposes as it might result in a consequent increase in data size. Additionally, when creating the signal, the haptic designer has to manually duplicate the same haptic effect multiple times which is cumbersome especially in case of modifications of the signal: the modification also needs to be duplicated or redone. Such approach is clearly unsatisfying for an interchange format used in the edition stage of the haptic file.

In addition, the frequency band decomposition for a given track is constant. It is not possible to divide a track in multiple parts with different band decomposition. This limits the possibilities from a designing perspective. For a given track (usually associated to a single haptic actuator), it may be useful to define different effects using different frequency ranges; simple effects might only require a single frequency band, while other effects could be decomposed in multiple layers.

Embodiments described hereafter have been designed with the foregoing in mind.

Embodiments introduce the notion of a haptic effect library allowing to define a haptic effect once and use it multiple times. Following types of haptic effects are defined:
Basis effects: Basis effect typically defines the signal data used to control a haptic actuator.
Timeline effects: Timeline effects are defined as a succession of effects, each effect being associated with a timestamp. The effects themselves may be defined directly using signal data or may rely on references to the haptic library effect.
Reference effects: are references to existing effects (identified with an “id” attribute) and are associated with a timestamp.

In a first embodiment, basis effects are defined based on the frequency decomposition in haptic bands introduced above. Haptic tracks are then composed of a set of timed haptic effects instead of a list of haptic bands. This solution allows to define haptic effects with different frequency bands within a track. This allows more flexibility to compress the signal by using different frequency bands which may increase the quality of the encoded signal or the compression level. This also offers great flexibility when designing the signal: haptic effects can be encoded using the most relevant band decomposition.

In a second embodiment, basis effects are defined based on keyframes. This solution allows to maximize the space optimization by storing lower level information that can be referenced more easily. With this solution, haptic effects defined in a given haptic band are not depending on the content described in another band.

Both embodiments allow to optimize the space consumption of haptic files. By defining haptic effects in an effect library and using the proposed referencing system, unnecessary data repetition can be avoided through data refactoring.

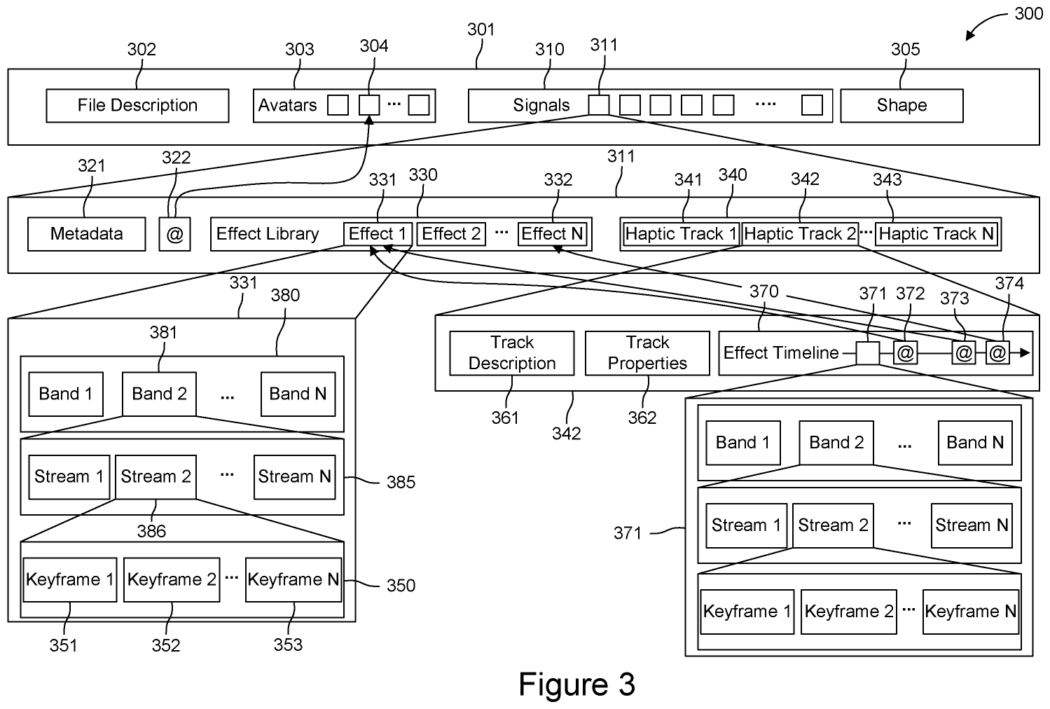

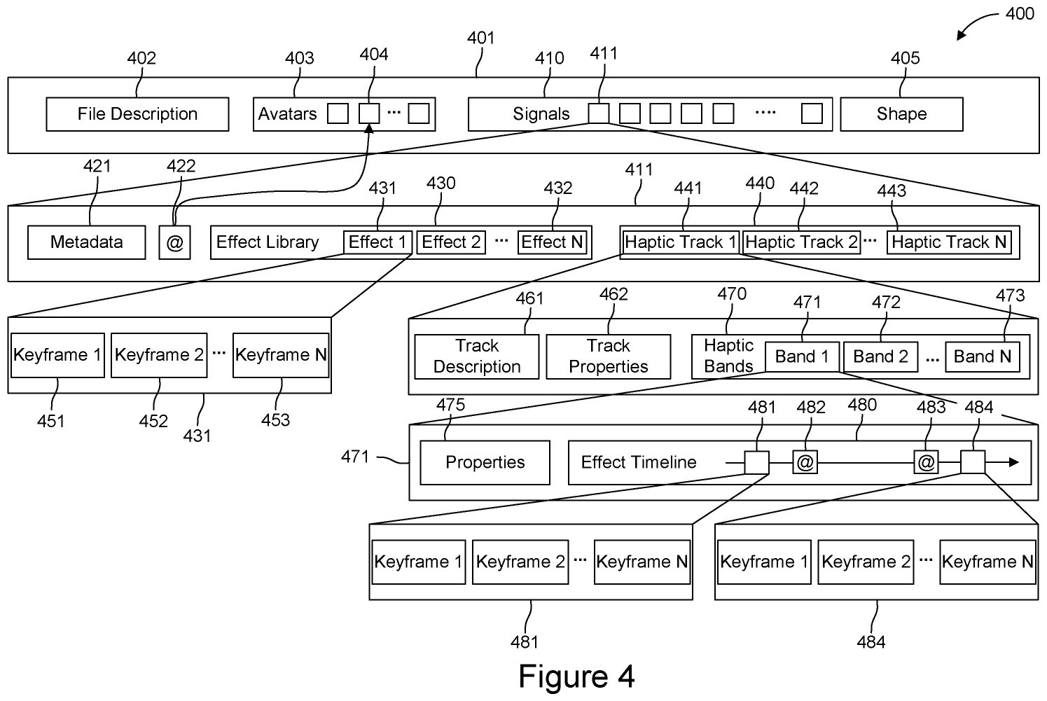

As illustrated in FIGS. 3 and 4, the proposed data structure allows that haptic effects may be used both in the effect library and directly within each track. Indeed, using the herein proposed data model for the definition of effect allows great flexibility: within each track, the effects can either be defined directly or simply reference existing ones from the library. Additionally, this model allows interesting data optimization for different purposes (for example for streaming without use of the library or edition with intensive use of the library to minimize manual operations during modifications of the haptic description file).

For instance, given an existing haptic file with multiple references to haptic effects in the library, the data can be reorganized by replacing the references with the actual effects. This linearization of the data makes the packaging of the data straightforward for streaming purposes. On the opposite, if a haptic file was designed for streaming purposes, with an empty effect library. Parsing the data to identify and extract identical effects to place them in the library could reduce drastically the size of the file.

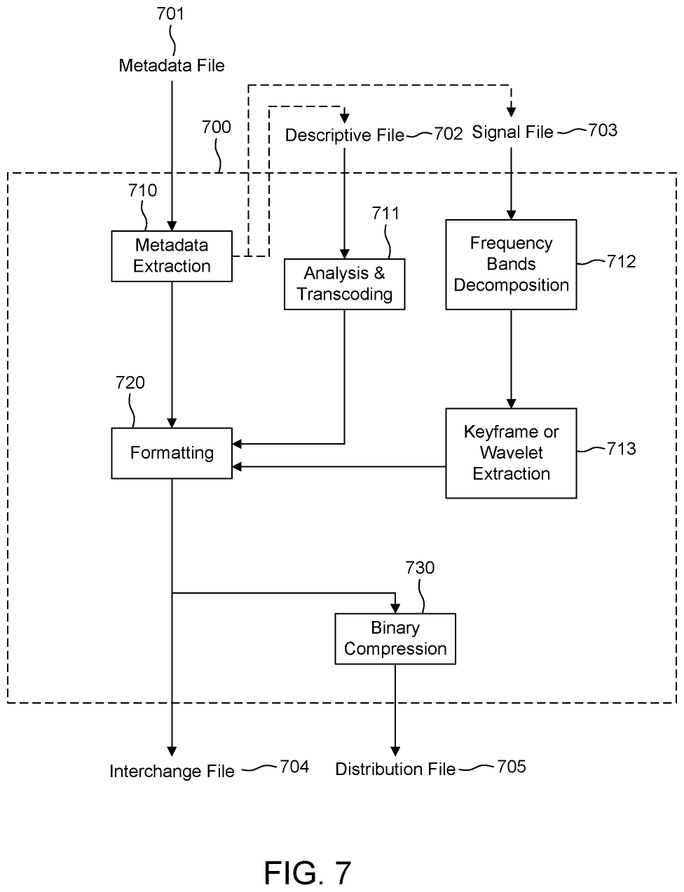

Such optimization may be introduced in the “binary compression” step 730 according to FIG. 7 or in the file loading/saving stage of a haptic editor.

FIG. 3 illustrates an example of data structure for haptic data according to at least a first embodiment. In this embodiment, basis effects are defined based on the frequency decomposition in haptic bands introduced above. Haptic tracks are then composed of a set of timed haptic effects instead of a list of haptic bands.

The haptic description file (in other words, the haptic data) 300 comprises a first level 301 comprising a file description 302, a set of avatars 303, a set of signals 310 and a shape 305. The file description 302 comprises some generic metadata including the version of the file, the date and a description of the associated haptic experience. The set of avatars 303 comprises the definition of body models on which a haptic effect is to be applied. The shape 305 determines the volume where the haptic effect is active within an immersive scene. Signals such as the signal 311 are aggregated into the set of signals 310. Despite its name, a signal is a relatively high-level concept that ties together haptic effects of similar categories (for example kinesthetic, temperature-based effect, etc.).

The signal 311 is expanded in the second line of the figure and comprises metadata 321, a reference 322 to an avatar selected in the set of avatars 303 (for example a reference to avatar 304), an effect library 330 and a set of haptic tracks 340. The metadata 321 comprises information on the type of haptic effect and corresponding signal (Vibration, Pressure, Temperature, etc.) as well as a description of the signal. The effect library comprises a set of effects such as effects 331 and 332. The example of effect 331 is expanded in the lower left-hand corner of the figure. The set of haptic tracks 340 aggregates several haptic tracks such as 341, 342 and 343. The haptic track 342 is also expanded in the middle-right of the figure.

The effect 331, according to the first embodiment, is defined based on the frequency decomposition in haptic bands. It comprises, at a first level, a set of bands 380, each band corresponding to a range of frequencies, for example the band 381. Each band comprises, at a second level, a set of streams 385, each stream corresponding to a portion of the signal in a given time frame and in a given frequency range. Each stream comprises, at a third level, a set of keyframes 350 (defined by a frequency and an amplitude). For example, the stream 386 comprises at least the keyframes 351, 352 and 353. These keyframes carry the signal that will be applied to the appropriate haptic actuator to finally render the haptic effect, similarly to the streams 271, 272, 273 and 274 of FIG. 2B. With such definition, each effect defined in the library comprises the minimal definition of the signal so that it may be reused multiple times within a haptic file.

The haptic track 342 comprises a track description 361 carrying semantic information, track properties 362 carrying some properties such as the gain, the mixing weight, a body part mask and an effect timeline 370. The effect timeline 370 comprises a set of referenced effects associated with a temporal reference such as a timestamp, for example the effects 371, 372, 373 and 374. For the temporal aspects, a timestamp may be associated to each effect. The decomposition of the effect 371 in the bottom-right corner of the figure shows that its structure is identical to an effect defined in the effect library, such as the effect 331.

With such data structure, the designer of the haptic file may choose, for each effect, if it is worth adding it to the effects library to further reference it from the effect timeline or to insert it directly in the effect timeline. Both alternatives are illustrated in the effect timeline 370: the effect 371 (probably used only once) is defined directly within the effect timeline, while the effects 372, 373 and 374 reference to effects from the library, respectively to the effect 331, 331, and 332. With this technique, the effect 331 that is used multiple times is only defined once, thus allowing to minimize the bandwidth and storage space required for the haptic file description.

As seen above, haptic effects can be of three types: Basis, Timeline or Reference. A basis effect is defined by a list of haptic bands describing a signal in the form of streams of waves (or keyframes). It is identified with an id. An example of basis effect is the effect 331 in the effect library. A timeline effect is also identified by an id, but it is defined with a timeline composed of timed effect. An example of timeline effect is the effect 371 in the effect timeline 370. Finally, reference effects are simply references to existing effects defined in the effects library. For this type of effect, the id attribute indicates the effect being referenced. An example of reference effect is the effect 373 in the effect timeline.

An example of JSON schema of a haptic effect according to the first embodiment is given in table 1.

```
TABLE 1
{
  ″$schema″ : ″http://json-schema.org/draft-04/schema″,
  ″title″ : ″Haptics_effect″,
  ″type″ : ″object″,
  ″properties″ : {
    ″id″: {
      ″type″: ″integer″,
      ″description″: ″Track id″
    },
    ″effect_type″: {
      ″type″: ″string″,
      ″enum″: [″Basis″, ″Timeline″, ″Reference″],
      ″description″: ″Type of effect: basis, reference or timeline″
    },
    ″description″: {
      ″type″: ″string″,
      ″description″: ″Description of the effect″
    },
    ″bands″: {
      ″type″: ″array″,
      ″description″: ″List of haptic bands″,
      ″items″: {
        ″type″: ″object″,
        ″$ref″: ″Haptics.band.schema.json″
      },
      ″minItems″: 1
    },
    ″timeline″: {
      ″type″: ″array″,
      ″items″:{
        ″type″: ″object″,
        ″properties″:{
          ″time″:{
            ″type″: ″number″,
            ″description″: ″Timestamp of the effect″
          },
          ″effect″:{
            ″type″: ″object″,
            ″$ref″: ″IDCC_haptics.reference.schema.json″
          }
        }
      }
    }
  },
  ″required″: [
    ″id″,
    ″effect_type″
  ]
}
```

The notion of haptic effect is introduced in the format. At the signal level, effects are stored as a list of effects in an “effect_library”. An example of JSON schema for a haptic signal is provided in table 2.

```
TABLE 2
  {
    ″$schema″ : ″http://json-schema.org/draft-04/schema″,
    ″title″ : ″Haptics_signal″,
    ″type″ : ″object″,
    ″properties″ : {
      ″signal_type″: {
        ″type″: ″string″,
        ″enum″: [″Pressure″, ″Force″, ″Acceleration″, ″Velocity″,
        ″Position″, ″Temperature″, ″Vibration″, ″Water″, ″Wind″,
″Other″],
        ″description″: ″Type of signal″
      },
      ″description″: {
        ″type″: ″string″,
        ″description″: ″Signal description″
      },
      ″encoding″: {
        ″type″: ″string″,
        ″enum″: [″Sinusoidal″, ″Wavelet″],
        ″description″: ″Type of encoding used for the signal″
      },
      ″avatar_id″: {
        ″type″: ″integer″,
        ″description″: ″ID of the body model″
      },
      ″signal_accessor″: {
        ″allOf″: [ { ″$ref″: ″Haptics_id.schema.json″ } ],
        ″description″: ″The index of an accessor containing the data.″
      },
      ″effect_library″: {
        ″type″: ″array″,
        ″description″: ″List of predefined effects to be referenced
        in the tracks″,
        ″items″: {
          ″type″: ″object″,
          ″$ref″: ″Haptics.effect.schema.json″
        }
      }
      ″tracks″: {
        ″type″: ″array″,
        ″description″: ″List of tracks ″,
        ″items″: {
          ″type″: ″object″,
          ″$ref″: ″Haptics.track.schema.json″
        },
        ″minItems″: 1
    }
    ″required″: [
      ″signal_type″,
      ″description″,
      ″encoding″,
      ″nb_tracks″,
      ″avatar_id″,
      ″effect_library″,
      ″tracks″
    ]
}
```

Effects defined at the signal level can then be referenced and used multiple times in multiple tracks. The effects are organized in each haptic track with a timeline as shown in the JSON schema of table 3.

```
TABLE 3
{
  ″$schema″ : ″http://json-schema.org/draft-04/schema″,
  ″title″ : ″Haptics_track″,
  ″type″ : ″object″,
  ″properties″ : {
    ″id″: {
      ″type″: ″integer″,
      ″description″: ″Track id″
    },
    ″description″: {
      ″type″: ″string″,
      ″description″: ″Track description″
    },
    ″gain″: {
      ″type″: ″number″,
      ″description″: ″Gain″,
      ″default″: 1.0
    },
    ″mixing_weight″: {
      ″type″: ″number″,
      ″description″: ″Mixing weight″,
      ″default″: 1.0
    },
    ″body_part_mask″: {
      ″type″: ″integer″,
      ″description″: ″Binary mask specifying body parts on
      which to apply the effect. One per track″,
      ″minimum″: 0,
      ″default″: 0
    },
    ″vertices″: {
      ″$ref″: ″Haptics_id.schema.json″,
      ″description″: ″The index of an accessor containing
      the vertices to stimulate.″
    },
    ″timeline″: {
      ″type″: ″array″,
      ″description″: ″Timeline of effects″,
      ″items″:{
        ″type″: ″object″,
        ″properties″:{
          ″time″:{
            ″type″: ″number″,
            ″description″: ″Timestamp of the effect″
          },
          ″effect″:{
            ″type″: ″object″,
            ″$ref″: ″Haptics_effect.schema.json″
          }
        }
      }
    }
  },
  ″required″: [
    ″id″,
    ″description″,
    ″body_part_mask″,
    ″timeline″
  ]
}
```

The table 4 gives an example of JSON syntax for a haptic file according to the first embodiment. In this example, the haptic file contains a single signal with a single track. The effect library contains one basis effect that is referenced multiple time in the track. The track also directly defines another haptic effect. With this solution, one track can contain haptic effects with different frequency bands.

```
TABLE 4
{
  ″version″: 1.0,
  ″date″: ″2021-11-19″,
  ″description″:″Example haptic file″
  ″avatars″: [
    {
      ″id″: 0,
      ″lod″: 1,
      ″type″:″Vibration″
    }
  ],
  ″shape″:0
  ″signals″: [
    {
      ″signal_type″:″Vibration″,
      ″description″:″Some vibration signal″,
      ″encoding″:″Sinusoidal″,
      ″avatar_id″: 0,
      ″effect_library″:[
        {
          ″id″:0,
          ″effect_type″:″Basis″,
          ″description″:″Short vibration″,
          ″bands″:[
            {
              ″band_type″:″Wave″,
              ″encoding_modality″:″Vectorial″,
              ″lower_frequency_limit″:100,
              ″upper_frequency_limit″:200,
              ″streams″:[
                {
                  ″position″:0.0,
                  ″phase″:0,
                  ″keyframes″:[
                    {
                        ″amplitude_modulation″:0.95,
                        ″frequency_modulation″:166.666,
                        ″relative_position″:0
                    },
                    {
                        ″amplitude_modulation″:0.65,
                        ″frequency_modulation″:166.666,
                        ″relative_position″:0.02
                    }
                  ]
                }
              ]
            }
          ]
        }
      ],
      ″tracks″:[
        {
          ″id″:0,
          ″description″:″Main track″,
          ″body_part_mask″:0,
          ″timeline″:[
            {
              ″time″:0,
              ″effect″:{
                ″id″:0
                ″effect_type″:″Reference″
              }
            },
            {
              ″time″:1.0,
              ″effect″:{
                ″id″:1,
                ″effect_type″:″Basis″,
                ″description″:″Short vibration″,
                ″bands″:[
                  {
                    ″band_type″:″Wave″,
                    ″encoding_modality″:″Vectorial″,
                    ″lower_frequency_limit″:200,
                    ″upper_frequency_limit″:300,
                    ″streams″:[
                      {
                        ″position″:0.0,
                        ″phase″:0,
                        ″keyframes″:[
                          {
                            ″amplitude_modulation″:0.5,
                            ″frequency_modulation″:200,
                            ″relative_position″:0
                          },
                          {
                            ″amplitude_modulation″:0.65,
                            ″frequency_modulation″:250,
                            ″relative_position″:0.1
                          }
                        ]
                      }
                    ]
                  }
                ]
              }
            },
            {
              ″time″:2,
              ″effect″:{
                ″id″:0,
                ″effect_type″:″Reference″
              }
            }
          ]
        }
      ]
    }
  ],
  ″accessors″:[ ],
  ″buffers″: [ ],
  ″bufferViews″:[ ]
}
```

FIG. 4 illustrates an example of data structure for haptic data according to at least a second embodiment. In this embodiment, basis effects are defined based on keyframes.

The haptic description file 400 (in other words, the haptic data) comprises a first level 401 comprising a file description 402, a set of avatars 403, a set of signals 410 and a shape 405. The file description 402 comprises some generic metadata including the version of the file, the date and a description of the associated haptic experience. The set of avatars 403 comprises the definition of body models on which a haptic effect is to be applied. The shape 405 determines the volume where the haptic effect is active within an immersive scene. Signals such as the signal 411 are aggregated into the set of signals 410.

The signal 411 is expanded in the second line of the figure and comprises metadata 421, a reference 422 to an avatar selected in the set of avatars 403 (for example a reference to avatar 404), an effect library 430 and a set of haptic tracks 440. The metadata 421 comprises information on the type of signal (Vibration, Pressure, Temperature, etc.) and a description of the signal. The effect library comprises a set of effects such as effects 431 and 432. The example of effect 431 is expanded in the lower left-hand corner of the figure. The set of haptic tracks 440 aggregates several haptic tracks such as 441, 442 and 443. The haptic track 441 is also expanded in the middle-right of the figure.

The effect library 430 is comprising a set of effects such as 431 and 432, defined as a set of keyframes representing values of the signal to be rendered. For example, the effect 431 is defined as composed of keyframes 451, 452, 453.

The haptic track 441 comprises a track description 461 carrying semantic information, track properties 462 carrying some properties such as the gain, the mixing weight, a body part mask and a set of haptics bands 470 such as 471, 472, 473. The example of haptic band 471 comprises some properties 475 and an effect timeline 480. The effect timeline comprises four elements 481, 482, 483 and 484. The elements 481 and 484 are directly defining the effect through a set of keyframes within the timeline while the elements 482 and 483 are referencing effects from the effect library, respectively the effects 431 and 432. Therefore, the element 482 is referencing the keyframes 451, 452, 453 through referencing the effect 431.

An example of JSON schema of a haptic effect according to the second embodiment is given in table 5.

```
TABLE 5
{
  ″$schema″ : ″http://json-schema.org/draft-04/schema″,
  ″title″ : ″Haptics_effect″,
  ″type″ : ″object″,
  ″properties″ : {
    ″id″: {
      ″type″: ″integer″,
      ″description″: ″Track id″
    },
    ″effect_type″: {
      ″type″: ″string″,
      ″enum″: [″Basis″, ″Timeline″, ″Reference″],
      ″description″: ″Type of effect: basis, reference or timeline″
    },
    ″description″: {
      ″type″: ″string″,
      ″description″: ″Description of the effect″
    },
    ″phase″: {
      ″type″: ″number″,
      ″description″: ″Phase of the effect″,
      ″minimum″: 0.0,
      ″maximum″: 6.28
    },
    ″keyframes″: {
      ″type″: ″array″,
      ″description″: ″List of keyframes″,
      ″items″: {
        ″type″: ″object″,
        ″$ref″: ″Haptics.keyframes.schema.json″
      },
      ″minItems″: 1
    },
    ″timeline″: {
      ″type″: ″array″,
      ″items″:{
        ″type″: ″object″,
        ″properties″:{
          ″time″:{
            ″type″: ″number″,
            ″description″: ″Timestamp of the effect″
          },
          ″effect″:{
            ″type″: ″object″,
            ″$ref″: ″Haptics_effect.schema.json″
          }
        }
      }
    }
  },
  ″required″: [
    ″id″,
    ″effect_type″
  ]
}
```

As seen above, haptic effects can be of three types: Basis, Timeline or Reference. A basis effect is defined with an id and comprises a list of haptic “keyframes”. When needed, a phase attribute may be added to the basis effect (not depicted in the figure). An example of basis effect is effect 331 in FIG. 4. A timeline effect is also identified by an id, but it is defined by a list of haptic keyframes associated to a timestamp. An example of timeline effect in FIG. 4 is the effect 481. Finally, reference effects are simply references to existing effects in the effect library: the id attribute indicates the effect being referenced. An example of timeline effect in FIG. 4 is the effect 482 that references the effect 431 and thus comprises the keyframes 451, 452, 453.

At the signal level, the set of effects are stored in the “effect_library” as illustrated in the example of JSON schema of table 6.

```
TABLE 6
  {
    ″$schema″ : ″http://json-schema.org/draft-04/schema″,
    ″title″ : ″Haptics_signal″,
    ″type″ : ″object″,
    ″properties″ : {
      ″signal_type″: {
        ″type″: ″string″,
        ″enum″: [″Pressure″, ″Force″, ″Acceleration″, ″Velocity″,
        ″Position″, ″Temperature″, ″Vibration″, ″Water″, ″Wind″,
″Other″],
        ″description″: ″Type of signal″
      },
      ″description″: {
        ″type″: ″string″,
        ″description″: ″Signal description″
      },
      ″encoding″: {
        ″type″: ″string″,
        ″enum″: [″Sinusoidal″, ″Wavelet″],
        ″description″: ″Type of encoding used for the signal″
      },
      ″avatar_id″: {
        ″type″: ″integer″,
        ″description″: ″ID of the body model″
      },
      ″signal_accessor″: {
        ″allOf″: [ { ″$ref″: ″Haptics_id.schema.json″ } ],
        ″description″: ″The index of an accessor containing the data.″
      },
      ″effect_library″: {
        ″type″: ″array″,
        ″description″: ″List of predefined effects to be referenced
        in the tracks″,
        ″items″: {
          ″type″: ″object″,
          ″$ref″: ″Haptics.effect.schema.json″
        }
      }
      ″tracks″: {
        ″type″: ″array″,
        ″description″: ″List of tracks ″,
        ″items″: {
          ″type″: ″object″,
          ″$ref″: ″Haptics.track.schema.json″
        },
        ″minItems″: 1
      }
    },
    ″required″: [
      ″signal_type″,
      ″description″,
      ″encoding″,
      ″nb_tracks″,
      ″avatar_id″,
    ″tracks″
    ]
}
```

The effects are used at the haptic band level, as shown in table 7.

```
TABLE 7
{
  ″$schema″ : ″http://json-schema.org/draft-04/schema″,
  ″title″ : ″Haptics_band″,
  ″type″ : ″object″,
  ″properties″ : {
    ″band_type″: {
      ″type″: ″string″,
      ″enum″: [″Wave″, ″Keyframe″, ″Transient″],
      ″description″: ″Specifies the type of data contained
      in the band″
    },
    ″encoding_modality″: {
      ″type″: ″string″,
      ″enum″: [″Quantized″, ″Vectorial″],
      ″description″: ″Specifies the encoding modality.
      The data can be Quantized or Vectorial″
    },
    ″window_length″: {
      ″type″: ″number″,
      ″description″: ″Duration of a haptic wave″
    },
    ″lower_frequency_limit″: {
      ″type″: ″number″,
      ″description″: ″Lower frequency limit of the band″,
      ″minimum″: 0.0,
      ″maximum″: 1000.0
    },
    ″upper_frequency_limit″: {
      ″type″: ″number″,
      ″description″: ″Upper frequency limit of the band″,
      ″minimum″: 0.0,
      ″maximum″: 1000.0
    },
    ″timeline″: {
      ″type″: ″array″,
      ″description″: ″Timeline of effects″,
      ″items″:{
        ″type″: ″object″,
        ″properties″:{
          ″time″:{
            ″type″: ″number″,
            ″description″: ″Timestamp of the effect″
          },
          ″effect″:{
            ″type″: ″object″,
            ″$ref″: ″Haptics_effect.schema.json″
          }
        }
      }
    }
  },
  ″required″: [
    ″band_data_type″,
    ″encoding_modality″,
    ″timeline″
  ]
}
```

The table 8 gives an example of JSON syntax for a haptic file according to the second embodiment, based on the same example than for the first embodiment (table 4). With this solution, basis effects are easier to define but then every effects of a given track uses the same frequency band decomposition.

```
TABLE 8
{
  ″version″: 1.0,
  ″date″: ″2021-11-19″,
  ″description″:″Example haptic file″
  ″avatars″:[
    {
      ″id″: 0,
      ″lod″: 1,
      ″type″:″Vibration″
    }
  ],
  ″shape″:0
  ″signals″: [
    {
      ″signal_type″:″Vibration″,
      ″description″:″Some vibration signal″,
      ″encoding″:″Sinusoidal″,
      ″avatar_id″: 0,
      ″effect_library″:[
        {
          ″id″:0,
          ″effect_type″:″Basis″,
          ″description″:″Short vibration″,
          ″phase″:0,
          ″keyframes″:[
            {
              ″amplitude_modulation″:0.95,
              ″frequency_modulation″:166.666,
              ″relative_position″:0
            },
            {
              ″amplitude_modulation″:0.65,
              ″frequency_modulation″:166.666,
              ″relative_position″:0.02
            }
          ]
        }
      ],
      ″tracks″:[
        {
          ″id″:0,
          ″description″:″Main track″,
          ″body_part_mask″:0,
          ″bands″:[
            {
              ″band_type″:″Wave″,
              ″encoding_modality″:″Vectorial″
              ″lower_frequency_limit″:100,
              ″upper_frequency_limit″:300,
              ″timeline″:[
                {
                  ″time″:0,
                  ″effect″:{
                    ″id″:0
                    ″effect_type″:″Reference″
                  }
                },
                {
                  ″time″:1,
                  ″effect″:{
                    ″id″:1,
                    ″effect_type″:″Basis″,
                    ″description″:″Short vibration″,
                    ″phase″:0,
                    ″keyframes″:[
                      {
                        ″amplitude_modulation″:0.5,
                        ″frequency_modulation″:200,
                        ″relative_position″:0
                      },
                      {
                        ″amplitude_modulation″:0.65,
                        ″frequency_modulation″:250,
                        ″relative_position″:0.1
                      }
                    ]
                  }
                },
                {
                  ″time″:2,
                  ″effect″:{
                    ″id″:0
                    ″effect_type″:″Reference″
                  }
                }
              ]
            }
          ]
        }
      ]
    }
  ],
  ″accessors″:[ ],
  ″buffers″: [ ],
  ″bufferViews″:[ ]
}
```

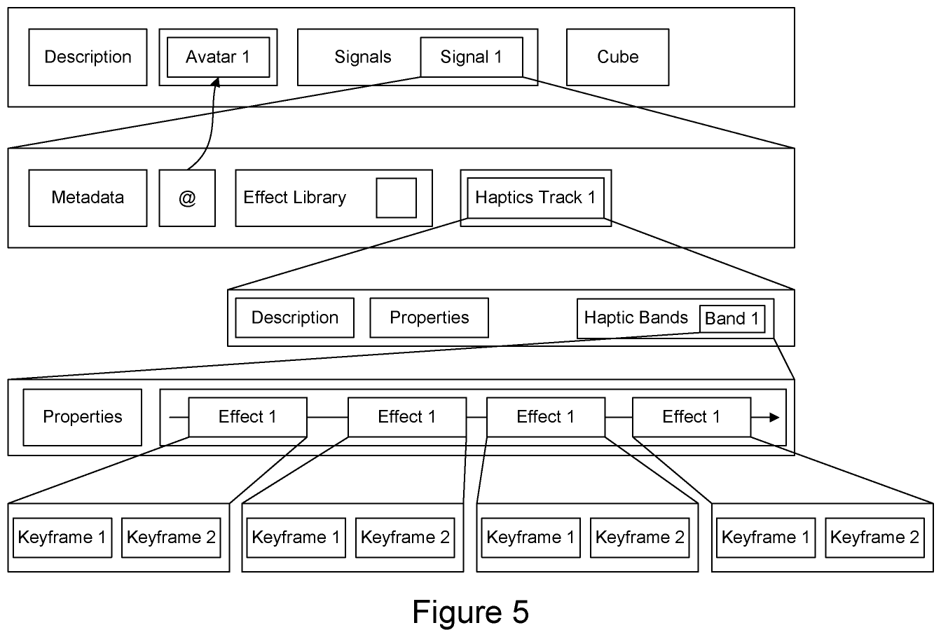

FIG. 5 illustrates an example of haptic file encoded according to the second embodiment without using the effect library. The data is stored linearly, and identical effects are repeated. Such haptic file would be particularly adapted for streaming.

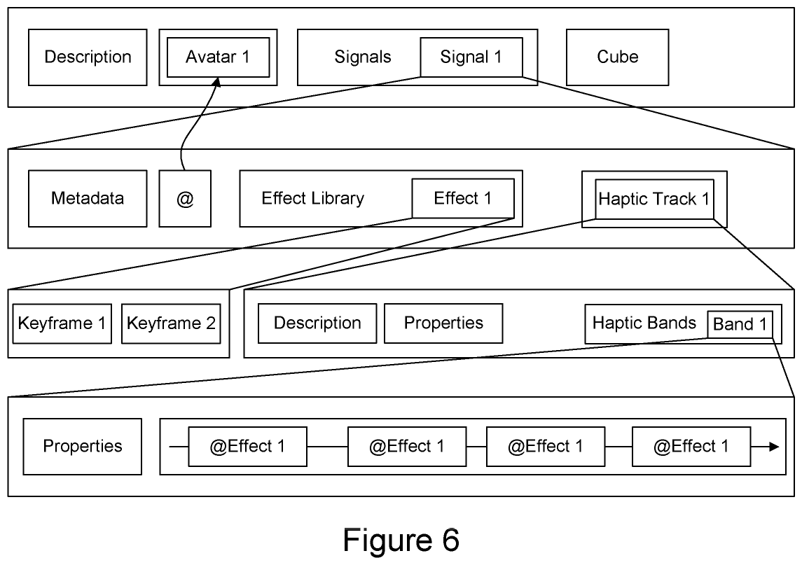

FIG. 6 illustrates an example of haptic file encoded according to the second embodiment using the effect library. This file describes the same effect but is optimized to reduce the space consumptions by using the effects library. Indeed, identical effects are moved to the effect library and then referenced in the timeline. Such haptic file would be particularly adapted for the edition stage. Indeed, if a modification needs to be done in the keyframes, it only needs to be done once.

FIG. 7 illustrates an example of architecture for an encoder 700 for haptic files according to at least one embodiment. The inputs are a metadata file 701 and at least one signal file 703. The metadata file 701 is for example based on the ‘OHM’ haptic object file format. The signal files are conventionally using PCM encoded files for example based on the WAV file format. The descriptive files 702 are for example based on the AHAP or HAPT file formats. The interchange file 704 is a human readable file for example based on glTF, XML or JSON formats. The distribution file 705 is a binary encoded file for example based on MPEG file formats adapted for streaming or broadcasting to a decoder device.

Metadata is extracted 710 from the metadata file 701, allowing to identify the descriptive files and/or signal files. Descriptive files are analyzed and transcoded in step 711. In step 712, signal files are decomposed in frequency bands and keyframes or wavelets are extracted in step 713. The interchange file 704 is then generated in step 720, in compliance with the data format according to one of the embodiments described herein. This file may be compressed in step 730 to be distributed in a transmission-friendly form, more compact than the interchange file format.

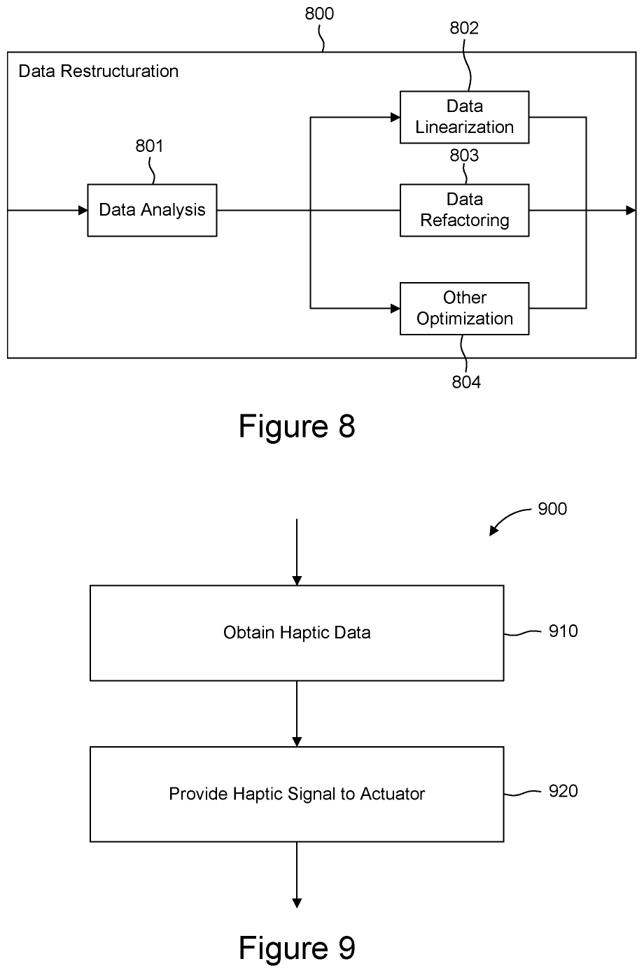

FIG. 8 illustrates a data restructuration process according to one embodiment. This process 800 allows for example to convert the file of FIG. 5 to the file of FIG. 6 and vice versa. In other words, it allows to adapt the structure of a haptic either to use linearized (thus duplicated) keyframes or to use a library effect that factorizes the keyframe description when possible. In a first step 801, the signal data is analyzed. Typically, in this step, the process examines the effects defined in the timeline to identify identical effects. In the example of FIG. 5, the process would have identified that the combination of keyframe 1 and keyframe 2 is used 4 times. In the second step, the process performs one of the optimizations. In the case of data linearization 802, the goal is to have a data structure best fit for streaming. In this case, library-based effect references in the timeline are replaced by a copy of the effect and all effects are removed from the library. In the case of data refactoring 803, the goal is opposite, in other words, compacting the data structure. For that purpose, when identical effects are detected in the timeline, such effect is added to the effect library (if it not yet exists) and in the timeline the effect is replaced by a reference to the effect in the library.

Other types of optimizations 804 could eventually be added to this process. For instance, instead of only merging identical effects, the process could merge effects that are similar enough to further optimize the gain in space. Such optimization would require additional computing during the signal analysis to evaluate some distance metrics between the effects. Associated distance thresholds would have to be provided to define the degree of similarity between effects to perform the merging.

This data restructuration process could be implemented in multiple manners. For example, it could be inserted after the formatting step 720 in the example architecture of FIG. 7. It could also be implemented as a standalone tool to restructure the data of an existing haptic file and reexport it (either as an interchange or a distribution file) or can be implemented as an import plugin for a haptic file edition tool. It could also be included to the binary compression step 730.

The table 9 gives an example of JSON syntax for a haptic file according to the second embodiment after a data linearization process. Indeed, the two examples of tables 4 and 8 are already optimized to save space and make the editing of haptic signals easier. For streaming purposes, this data organization is not convenient. The following table shows the same example after linearization of the data. The process replaces every reference to an effect by a copy of the effect and removes the original reference from the library. Based on the second embodiment, the data restructuration results in the following file, much longer, but easier to stream.

```
TABLE 9
{
  ″version″: 1.0,
  ″date″: ″2021-11-19″,
  ″description″:″Example haptic file″
  ″avatars″: [
    {
      ″id″: 0,
      ″lod″: 1,
      ″type″:″Vibration″
    }
  ],
  ″shape″:0
  ″signals″: [
    {
      ″signal_type″:″Vibration″,
      ″description″:″Some vibration signal″,
      ″encoding″:″Sinusoidal″,
      ″avatar_id″: 0,
      ″effect_library″:[ ],
      ″tracks″:[
        {
          ″id″:0,
          ″description″:″Main track″,
          ″body_part_mask″:0,
          ″bands″:[
            {
              ″band_type″:″Wave″,
              ″encoding_modality″: ″Vectorial″
              ″lower_frequency_limit″:100,
              ″upper_frequency_limit″:300,
              ″timeline″:[
                {
                  ″time″:0,
                  ″effect″:{
                    ″id″:0,
                    ″effect_type″:″Basis″,
                    ″description″:″Short vibration″,
                    ″phase″:0,
                    ″keyframes″:[
                      {
                        ″amplitude_modulation″:0.95,
                        ″frequency_modulation″:166.666,
                        ″relative_position″:0
                      },
                      {
                        ″amplitude_modulation″:0.65,
                        ″frequency_modulation″:166.666,
                        ″relative_position″:0.02
                      }
                    ]
                  }
                },
                {
                  ″time″:1,
                  ″effect″:{
                    ″id″:1,
                    ″effect_type″:″Basis″,
                    ″description″:″Short vibration″,
                    ″phase″:0,
                    ″keyframes″:[
                      {
                        ″amplitude_modulation″:0.5,
                        ″frequency_modulation″:200,
                        ″relative_position″:0
                      },
                      {
                        ″amplitude_modulation″:0.65,
                        ″frequency_modulation″:250,
                        ″relative_position″:0.1
                      }
                    ]
                  }
                },
                {
                  ″time″:2,
                  ″effect″:{
                    ″id″:0,
                    ″effect_type″:″Basis″,
                    ″description″:″Short vibration″,
                    ″phase″:0,
                    ″keyframes″:[
                      {
                        ″amplitude_modulation″:0.95,
                        ″frequency_modulation″:166.666,
                        ″relative_position″:0
                      },
                      {
                        ″amplitude_modulation″:0.65,
                        ″frequency_modulation″:166.666,
                        ″relative_position″:0.02
                      }
                    ]
                  }
                }
              ]
            }
          ]
        }
      ]
    }
  ],
  ″accessors″:[ ],
  ″buffers″:[ ],
  ″bufferViews″:[ ]
}
```

In this document, we illustrate the proposed data structure with the JSON readable format, but the same principles apply to the binary version of the format as used in a distribution file.

FIG. 9 illustrates an example of process for rendering haptic data according to at least one embodiment. This process 900 is for example implemented by a processor 101 of the device 100 of FIG. 1. In step 910, the processor obtains haptic data. In step 920, the processor provides the haptic signal to a haptic actuator as described by the haptic data.

Although different embodiments have been described separately, any combination of the embodiments together can be done while respecting the principles of the disclosure.

Although embodiments are related to haptic effects, the person skilled in the art will appreciate that the same principles could apply to other effects such as the sensorial effects for example and thus would comprise smell and taste. Appropriate syntax would thus determine the appropriate parameters related to these effects.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Additionally, this application or its claims may refer to “obtaining” various pieces of information. Obtaining is, as with “accessing”, intended to be a broad term. Obtaining the information may include one or more of, for example, receiving the information, accessing the information, or retrieving the information (for example, from memory or optical media storage). Further, “obtaining” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1. A method comprising:
generating haptic data comprising information representative of:
a type of effect,
a library of haptic effects, wherein a haptic effect is identified by a reference and comprises information representative of values of a signal to be applied to render the haptic effect, and
a list of haptic tracks, wherein a haptic track comprises a timeline, wherein the timeline comprises a list of references of haptic effects of the library of haptic effects, and wherein a temporal reference is associated to a reference.

2. The method of claim 1 wherein signals are grouped according to a set of frequency bands.

3. The method of claim 1 wherein timelines are grouped according to a set of frequency bands.

4. A method for rendering haptic data comprising:
obtaining haptic data comprising information representative of:
a type of effect,
a library of haptic effects, wherein a haptic effect is identified by a reference and comprises information representative of values of a signal to be applied to render the haptic effect, and
a list of haptic tracks, wherein a haptic track comprises a timeline, wherein the timeline comprises a list of references of haptic effects of the library of haptic effects, and wherein a temporal reference is associated to a reference, and
providing values of the signal to haptic actuators.

5. The method of claim 4 wherein signals are grouped according to a set of frequency bands.

6. The method of claim 4 wherein timelines are grouped according to a set of frequency bands.

7. A haptic rendering device comprising a processor configured to:
obtain haptic data comprising information representative of:
a type of effect,
a library of haptic effects, wherein a haptic effect is identified by a reference and comprises information representative of values of a signal to be applied to render the haptic effect,
a list of haptic tracks, wherein a haptic track comprises a timeline, wherein the timeline comprises a list of references of haptic effects of the library of haptic effects, and wherein a temporal reference is associated to a reference, and
provide values of the signal to haptic actuators.

8. The device of claim 7 wherein signals are grouped according to a set of frequency bands.

9. The device of claim 7 wherein timelines are grouped according to a set of frequency bands.

10-19. (canceled)

20. A non-transitory computer readable storage medium having stored instructions that, when executed by a processor, cause the processor to perform the method of claim 1.

21. A non-transitory computer readable storage medium having stored instructions that, when executed by a processor, cause the processor to perform the method of claim 2.

22. A non-transitory computer readable storage medium having stored instructions that, when executed by a processor, cause the processor to perform the method of claim 3.

23. A non-transitory computer readable storage medium having stored instructions that, when executed by a processor, cause the processor to perform the method of claim 4.

24. A non-transitory computer readable storage medium having stored instructions that, when executed by a processor, cause the processor to perform the method of claim 5.

25. A non-transitory computer readable storage medium having stored instructions that, when executed by a processor, cause the processor to perform the method of claim 6.
